(19) United States
(12) Patent Application Publication
(10) Pub. No.: US 2026/0261651 A1
(43) Pub. Date: Sep. 3, 2026

(54) METHOD FOR VIDEO DECODING, METHOD FOR VIDEO ENCODING, AND STORAGE MEDIUM

(71) Applicant: GUANGDONG OPPO MOBILE TELECOMMUNICATIONS CORP., LTD., Dongguan (CN)

(72) Inventors: Jonathan GAN, Palo Alto, CA (US); Yue YU, Palo Alto, CA (US); Haoping YU, Palo Alto, CA (US)

(21) Appl. No.: 19/636,693

(22) Filed: Apr. 1, 2026

Related U.S. Application Data
(63) Continuation of application No. PCT/CN2024/120142, filed on Sep. 20, 2024.
(60) Provisional application No. 63/543,022, filed on Oct. 6, 2023.

(51) Int. Cl. H04N 19/105; H04N 19/119; H04N 19/176; H04N 19/18; H04N 19/60

(52) U.S. Cl. CPC H04N 19/105; H04N 19/119; H04N 19/176; H04N 19/18; H04N 19/60

(57) ABSTRACT

A method for video decoding is provided. The method includes the following. A first region and a second region of a current block are determined, where the second region is a region in the current block excluding the first region. Samples in the first region of the current block are derived by performing a non-separable transform on one or more coefficients.

### CROSS REFERENCE TO RELATED APPLICATION(S)

This application is a continuation of International Application No. PCT/CN2024/120142, filed Sep. 20, 2024, which claims priority to U.S. Provisional Application No. 63/543,022, filed Oct. 6, 2023, the disclosures of which are hereby incorporated by reference in their entireties.

### TECHNICAL FIELD

The present disclosure relates to imaging and video coding technologies. More particularly, methods for video decoding and encoding and a storage medium are disclosed herein.

### BACKGROUND

Existing video compression methods, such as High Efficiency Video Coding (HEVC) and Versatile Video Coding (VVC) perform blocking and quantization processes when encoding. The HEVC and VVC standards specify a block-based, hybrid spatial and temporal predictive coding scheme. During coding, an input picture is first divided into square blocks called CTUs (Coding Tree Units). Each CTU in a picture can be partitioned into one or more Coding Units (CUs), which can be used for prediction and transform. A variety of prediction tools may be used, including inter-prediction and intra-prediction tools. Inter-prediction tools may use any information from pictures that have been previously coded to a bitstream. On the other hand, intra-prediction tools may only use reconstructed samples from the same picture. Inter-prediction tools may use any information that has been previously encoded to a bitstream, such as samples from other pictures. Intra-prediction tools may only use reconstructed samples from the same picture. Implementing various intra-prediction and inter-prediction tools requires significant amount of computing resources and storage space due to various types of parameters/data/information required for the prediction tools. Therefore, it is advantageous to have an improved system and method to address the foregoing needs.

### SUMMARY

In a first aspect, a method for video decoding is provided. The method includes the following. A first region and a second region of a current block are determined, where the second region is a region in the current block excluding the first region. Samples in the first region of the current block are derived by performing a non-separable transform on one or more coefficients.

In a second aspect, a method for video encoding is provided. The method includes the following. A first region and a second region of a current block are determined, where the second region is a region in the current block excluding the first region. One or more coefficients are derived by performing a non-separable transform on samples in the first region of the current block.

In a third aspect, a method for video decoding is provided. The method includes the following. A video bitstream is received. Whether a non-separable transform is enabled for a current block is determined. In response to a determination that the non-separable transform is enabled, samples in the current block are derived by performing a non-separable transform on one or more coefficients decoded from the video bitstream.

In a fourth aspect, a non-transitory computer-readable storage medium storing computer programs and a bitstream is provided. When executed by a processor, the computer programs cause the processor to perform the method in the second aspect to generate the bitstream.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1A is a schematic diagram illustrating an encoding system in accordance with one or more implementations of the present disclosure.

FIG. 1B is a schematic diagram illustrating a decoding system in accordance with one or more implementations of the present disclosure.

FIG. 2 is a flowchart illustrating a decoding method in accordance with one or more implementations of the present disclosure.

FIG. 3 is a flowchart illustrating a decoding sub-method of FIG. 2 in accordance with one or more implementations of the present disclosure.

FIG. 4A is a schematic diagram illustrating a gradient analysis process in accordance with one or more implementations of the present disclosure.

FIG. 4B is a schematic diagram illustrating a template matching process in accordance with one or more implementations of the present disclosure.

FIG. 5 is a schematic diagram illustrating partitioning by an SBT tool in accordance with one or more implementations of the present disclosure.

FIG. 6 is a schematic diagram of a wireless communication system in accordance with one or more implementations of the present disclosure.

FIG. 7 is a schematic block diagram of a terminal device in accordance with one or more implementations of the present disclosure.

FIG. 8 is a schematic block diagram of an electronic device in accordance with one or more implementations of the present disclosure.

FIG. 9 is a flowchart of a decoding method in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

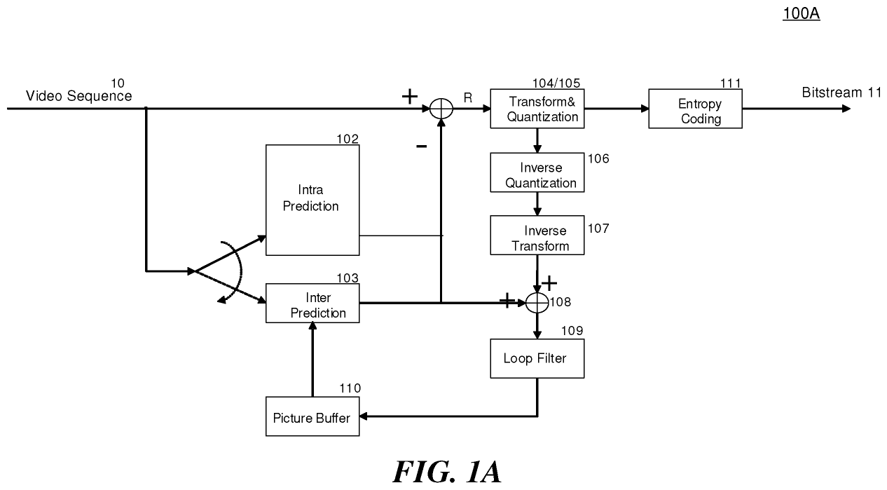

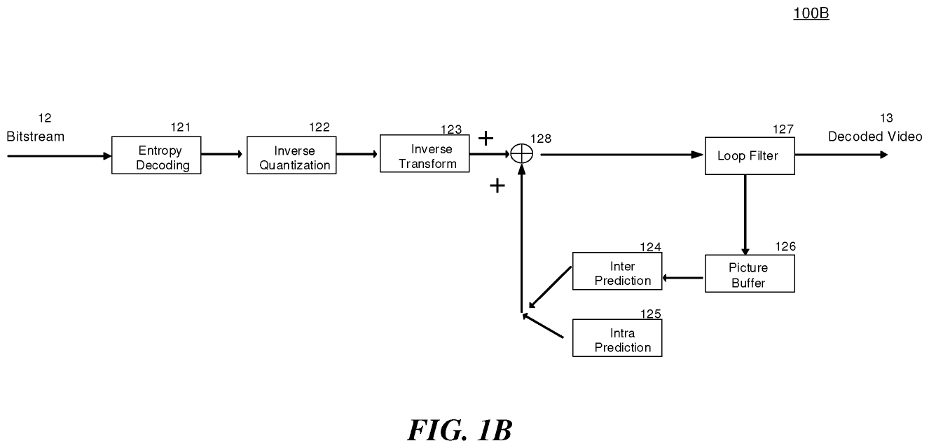

FIG. 1A is a schematic diagram illustrating an encoding system 100A in accordance with one or more implementations of the present disclosure. The encoding system 100A includes a video sequence 10 as input to an intra prediction module 102 and/or an inter prediction module 103. The intra prediction module 102 can perform prediction according to any of several intra-prediction tools, such as (but not restricted to) intra block copy (IBC), intra template matching prediction (intraTMP), spatial geometric partitioning mode (SGPM), matrix-based intra prediction (MIP), decoder-side intra mode derivation (DIMD), template-based intra mode derivation (TIMD), or regular angular intra prediction signaled through most probable mode syntax elements. Similarly, the inter prediction module 103 can perform prediction according to any of several inter-prediction tools, such as (but not restricted to) merge mode, template matching, geometric partitioning mode (GPM), affine mode, decoder-side motion vector refinement, or regular uni/bi prediction by motion compensation vectors signaled by motion vector differences.

The output of the intra prediction module 102 and/or the inter prediction module 103 can be subtracted from a current CU of the video sequence 10 to generate a residual R. Then the residual R can be directed to a transform module 104. The output of the transform module 104 can be quantized by a quantization module 105. The output of the quantization module 105 can then be directed to an inverse quantization module 106 and an inverse transform module 107.

As shown in FIG. 1A, at an adder 108, the output of the intra prediction module 102 and/or the inter prediction module 103 can be added with the output of the inverse transform module 107. The added result can then be directed to an in-loop filter 109. The output of the in-loop filter 109 can then be directed to a decoded picture buffer 110 for further processes by the inter prediction module 103. The encoding system 100A uses loop filters to suppress compression artifacts and reduce distortion. These loop filters include a deblocking filter (DBF), a sample adaptive offset (SAO) filter, and an adaptive loop filter (ALF). In some embodiments, the in-loop filter 109 is not required to include all of the filters described above. In some embodiments, the DBF and the SAO filter are two filters designed to reduce artifacts caused by an encoding process. The DBF focuses on visual artifacts at block boundaries. The SAO filter complementarily reduces artifacts that may arise from quantization of transform coefficients within blocks. The ALF can enhance an adaptive filter of a reconstructed signal, reducing a mean square error (MSE) between the original and reconstructed samples by using a Wiener-based adaptive filter. The encoding system 100A also includes an entropy coding module 111 configured to perform data compression before generating a bitstream 11.

FIG. 1B is a schematic diagram illustrating a decoding system 100B in accordance with one or more implementations of the present disclosure. The decoding system 100B includes an entropy decoding module 121, an inverse quantization module 122, and an inverse transform module 123 configured to process a bitstream 12. The decoding system 100B also includes an inter prediction module 124 and an intra prediction module 125 (e.g., corresponding to the inter prediction module 103 and the intra prediction module 102 at the encoding side). The inter prediction module 124 and the intra prediction module 125 are configured to process the bitstream 12 and generate a decoded video 13. As shown in FIG. 1B, the decoding system 100B also includes a picture buffer 126 and a loop filter 127 to facilitate the foregoing decoding tasks.

As shown in FIG. 1B, at an adder 128, the output of the intra prediction module 125 and/or the inter prediction module 124 can be added with the output of the inverse transform module 123. The added result can then be directed to the loop filter 127 to generate the decoded video 13.

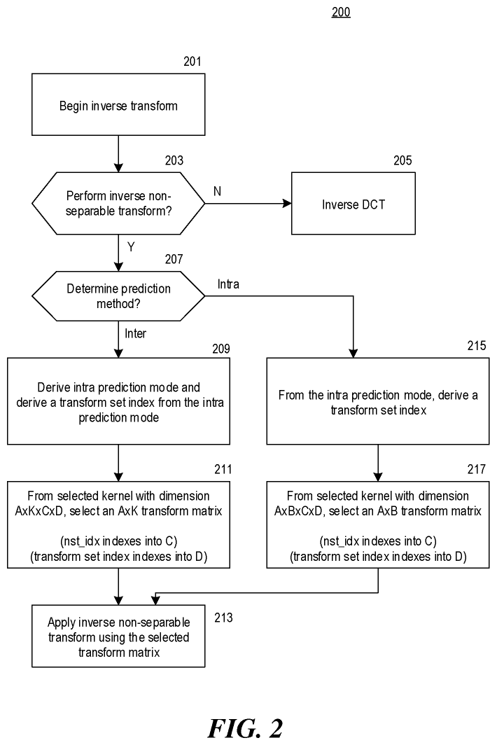

FIG. 2 is a flowchart illustrating an inverse transform method 200 in accordance with one or more implementations of the present disclosure. In some embodiments, the method 200 can be implemented by an inverse transform module (e.g., the inverse transform module 123 discussed in FIG. 2). The method 200 begins at step 201 and then moves to decision step 203.

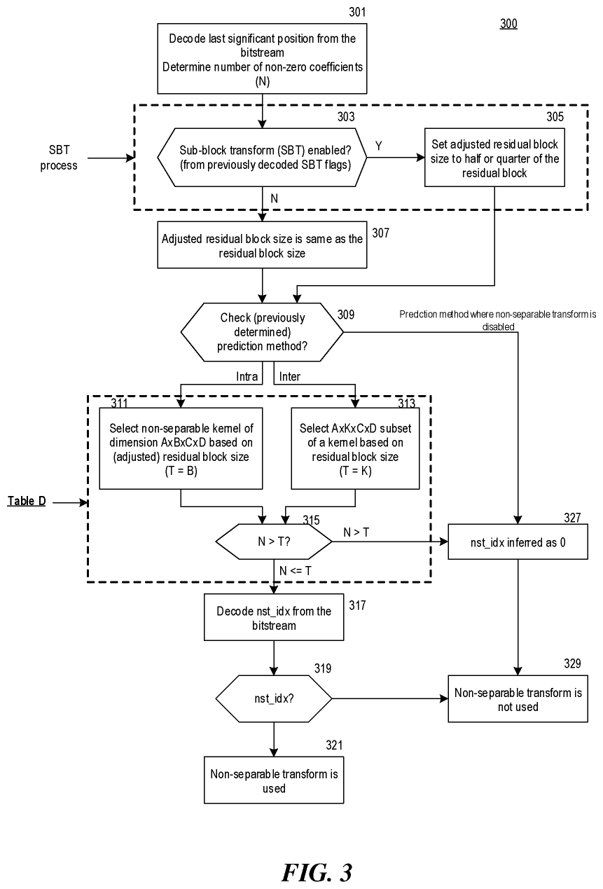

At decision step 203, the method 200 determines whether to perform an inverse non-separable transform based on a non-separable transform index, referred to in this disclosure by “nst_idx”. The nst_idx parameter may be decoded from the bitstream 12 or inferred. Decision step 203 and determination of the nst_idx parameter are described in further detail below with reference to FIG. 3 and method 300. If the nst_idx is “0,” then the method 200 does not perform the inverse non-separable transform. The process moves to step 205 to implement an alternative inverse transform process (e.g., an inverse discrete cosine transform (DCT)) and terminates. Otherwise, if the nst_idx is not “0” (e.g., “1”, “2”, or “3”), then the method 200 moves to decision step 207.

At decision step 207, the method 200 determines whether a current prediction method is “inter prediction” or “intra prediction”. If the current prediction method is “intra prediction,” the method 200 moves to step 215. If the current prediction method is “inter prediction,” the method 200 moves to step 209.

At step 215, the current intra prediction method may already determine an intra prediction mode. Alternatively, if the current intra prediction method (such as MIP, intraTMP or IBC) does not select an intra prediction mode, an intra prediction mode is derived using DIMD. Once the intra prediction mode is determined, at step 215 the method 200 also derives a transform set index. The transform set index (“TrSetIdx”) is determined from the intra prediction mode using a mapping such as shown in Table 1 below. The method 200 then moves to step 217.

TABLE 1

| Intra prediction mode | TrSetIdx |
|---|---|
| predModeIntra < 0 | 2 |
| 0 <= predModeIntra <= 34 | predModeIntra |
| 35 <= predModeIntra <= 66 | 68 - predModeIntra |
| 67 <= predModeIntra <= 80 | 2 |

At step 217, the method 200 determines a selected transform matrix. Firstly, a transform kernel with dimensions “A×B×C×D” is selected depending on the block size of the current residual block. The current residual block may also be referred to as the current transform block, or “TB.” In some embodiments, a transform kernel with dimensions as shown in Table 2 below may be selected. “4×N,” “N×4,” “8×N” and “N×8” refer to block sizes with a dimension N which do not match earlier entries in the table. For example, for a block size of 4×8, a transform kernel with dimensions “32×20×3×35” is selected. For a block size of 4×64, since the dimensions do not exactly match any of the previous entries in Table 3, the entry for “4×N” block sizes is used and a transform kernel with dimensions “16×16×3×35” is selected. In addition to the kernel dimensions, the block size of the residual block determines what type of non-separable transform is used. Both a low-frequency non-separable secondary transform (LFNST) and a non-separable primary transform (NSPT) are selectable, but at most only one can be selected for a specific block size. The first seven rows of Table 2 select transform kernels for an NSPT, while the last three rows of Table 2 select transform kernels for an LFNST. The selectable transform kernels have pre-determined coefficient weights known by the decoding system 100B and encoding system 100A.

TABLE 2

| | | Number of transform |
|---|---|---|
| Block size | Kernel dimension | coefficients |
| 4 × 4 | 16 × 16 × 3 × 35 | 16 |
| 4 × 8 or 8 × 4 | 32 × 20 × 3 × 35 | 20 |
| 4 × 16 or 16 × 4 | 64 × 24 × 3 × 35 | 24 |
| 8 × 8 | 64 × 32 × 3 × 35 | 32 |
| 8 × 16 or 16 × 8 | 128 × 40 × 3 × 35 | 40 |
| 4 × 32 or 32 × 4 | 128 × 20 × 3 × 35 | 20 |
| 8 × 32 or 32 × 8 | 256 × 24 × 3 × 35 | 24 |
| 4 × N or N × 4 | 16 × 16 × 3 × 35 | 16 |
| 8 × N or N × 8 | 64 × 32 × 3 × 35 | 32 |
| 16 × 16 or larger | 96 × 32 × 3 × 35 | 32 |

After selecting the transform kernel, at step 217 a transform matrix with dimensions “A×B” is selected from the transform kernel by using the parameter nst_idx to index into the third dimension “C” of the kernel, and using the parameter TrSetIdx to index into the fourth dimension “D” of the kernel. “A” corresponds to the number of coefficients in the current residual block. “B” corresponds to the maximum number of non-separable transform coefficients that are decoded from the bitstream 12 for the current residual block. For example, in Table 2 “C” is equal to 3, corresponding to nst_idx being signaled with values of 0, 1, 2 or 3, where the value 0 indicates the inverse non-separable transform is not performed, and values 1, 2 or 3 select different nst_idx sets. “D” is equal to 35, corresponding to the example mapping of Table 1, where TrSetIdx can be determined with a value in the range of 0 to 34. For a block size of 4×8, a transform matrix with dimensions “32×20” is selected from the “32×20×3×35” transform kernel, meaning that “A” is equal to 32 and “B” is equal to 20. The method 200 then moves to step 213.

At step 213, the method 200 performs an inverse non-separable transform using the selected transform matrix. In some implementations, the inverse non-separable transform may be performed by arranging the transform coefficients into a vector, then performing a matrix multiplication with the selected transform matrix, resulting in an output vector with “A” values. The output vector values may then be distributed to the coefficient positions in the current residual block. The method 200 then terminates.

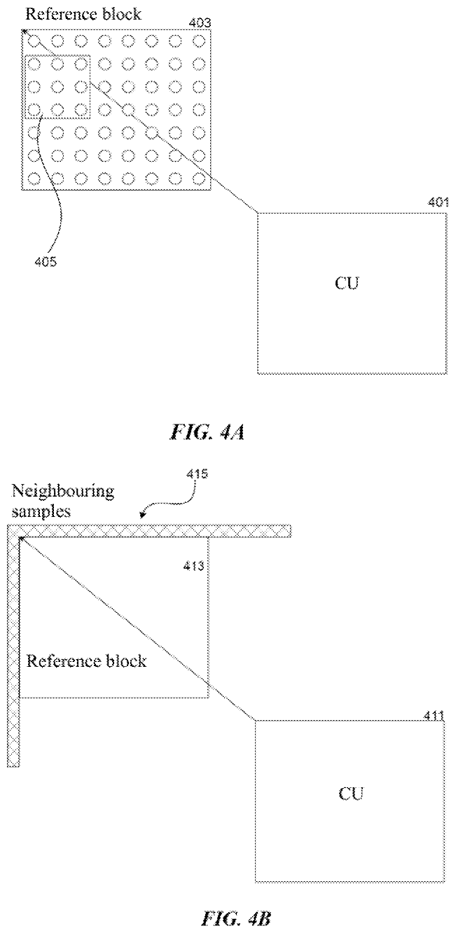

At step 209, the method derives an intra prediction mode, even though no intra prediction method will be performed. The intra prediction mode can be determined based on methods discussed herein (e.g., with reference to FIGS. 1, 4A, and 4B).

Once the intra prediction mode is determined, at step 209 the method 200 also derives a transform set index. In some embodiments, the transform set index (“TrSetIdx”) is determined from the intra prediction mode according to Table 1 in a similar manner as described above for step 215. In other embodiments of step 209, the transform set index may be determined based on both the type of current inter prediction method and the intra prediction mode. An example mapping from the inter prediction method and the intra prediction mode to the transform set index is shown in Table 3 below. The method 200 then moves to step 211.

TABLE 3

| Inter prediction method | Intra prediction mode | TrSetIdx |
|---|---|---|
| Translation inter prediction | predModeIntra < 0 | 1 |
| | 0 <= predModeIntra <= 1 | 0 |
| | 2 <= predModeIntra <= 12 | 1 |
| | 13 <= predModeIntra <= 23 | 2 |
| | 24 <= predModeIntra <= 44 | 3 |
| | 45 <= predModeIntra <= 55 | 2 |
| | 56 <= predModeIntra <= 80 | 1 |
| Affine inter prediction | predModeIntra < 0 | 5 |
| | 0 <= predModeIntra <= 1 | 4 |
| | 2 <= predModeIntra <= 12 | 5 |
| | 13 <= predModeIntra <= 23 | 6 |
| | 24 <= predModeIntra <= 44 | 7 |
| | 45 <= predModeIntra <= 55 | 6 |
| | 56 <= predModeIntra <= 80 | 5 |
| | . . . | |

At step 211, the method 200 determines a selected transform matrix. In some embodiments, firstly a transform kernel with dimensions “A×B×C×D” is selected depending on the block size of the current residual block. After selecting the transform kernel, at step 211 a transform matrix with dimensions “A×B” is selected from the transform kernel. The foregoing process is the same as the process described above at step 217 and may reuse the transform kernel coefficients already stored in the decoding system 100B and encoding system 100A to implement step 217. The method 200 then moves to step 213 to perform the inverse non-separable transform using the selected transform matrix.

In other embodiments of step 211, a transform kernel with dimensions “A×K×C×D” is selected depending on the block size of the current residual block, where K is less than B for some residual block sizes. In some embodiments, a transform kernel with dimensions as shown in Table 4 below may be selected. The selectable transform kernels may be subsets of the transform kernels described above at step 217, and therefore may reuse in part the transform kernel coefficients already stored in the decoding system 100B and encoding system 100A to implement step 217. For example, for a particular block size if the number of transform coefficients is reduced to K, the first K of the “B” basis vectors in the “A×B×C×D” transform kernel are used and the remaining basis vectors are ignored. After selecting the transform kernel, at step 211 a transform matrix with dimensions “A×K” is selected from the transform kernel. The method 200 then moves to step 213 to perform the inverse non-separable transform using the selected transform matrix.

TABLE 4

| | | Number of transform |
|---|---|---|
| Block size | Kernel dimension | coefficients |
| 4 × 4 | 16 × 16 × 3 × 35 | 16 |
| 4 × 8 or 8 × 4 | 32 × 20 × 3 × 35 | 16 |
| 4 × 16 or 16 × 4 | 64 × 24 × 3 × 35 | 20 |
| 8 × 8 | 64 × 32 × 3 × 35 | 28 |
| 8 × 16 or 16 × 8 | 128 × 40 × 3 × 35 | 32 |
| 4 × 32 or 32 × 4 | 128 × 20 × 3 × 35 | 20 |
| 8 × 32 or 32 × 8 | 256 × 24 × 3 × 35 | 24 |
| 4 × N or N × 4 | 16 × 16 × 3 × 35 | 12 |
| 8 × N or N × 8 | 64 × 32 × 3 × 35 | 24 |
| 16 × 16 or larger | 96 × 32 × 3 × 35 | 24 |

In other embodiments of step 211, a transform kernel with dimensions “A2×B2×C2×D2” is selected depending on the block size of the current residual block, where the transform kernel coefficients are different from the transform kernel coefficients used to implement step 217. The transform kernel dimensions are not required to be the same as “A×B×C×D.” For example, in the mapping of Table 3, TrSetIdx can be determined with a value in the range of 0 to 7 and so “D2” is equal to 8.

In this disclosure, the convention is taken to refer to transforms at the encoder as “forward transforms” generally transforming signals from the spatial domain to the transform domain, while transforms at the decoder are referred to as “inverse transforms” transforming signals from the transform domain back to the spatial domain. However, in other literature such as video standard specifications which only describe operation of the decoder, such “inverse transforms” may equivalently be referred to simply as “transforms”.

FIG. 3 is a flowchart illustrating a decoding method 300 in accordance with one or more implementations of the present disclosure. The decoding method 300 can be implemented by a decoder (such as the decoding system 100B discussed herein). The decoding method 300 may be implemented as a sub-method of step 203 in the method 200 described above with reference to FIG. 2. At step 301, a last significant position from bitstream 12 is decoded. Then from the last significant position, a number of potentially non-zero coefficients (N) is also determined. The method 300 then moves to a decision step 303.

At decision step 303, the method 300 determines whether a sub-block transform (SBT) is enabled. In some embodiments, the determination can be based on a previously decoded SBT flag (i.e., signaled). The SBT tool relates to whether a CU is partitioned by a horizontal or vertical split and has a “zero-out” region. If the SBT tool is enabled for the current CU, the method 300 moves to step 305. Otherwise, if the SBT tool is not enabled, the method 300 moves to step 307.

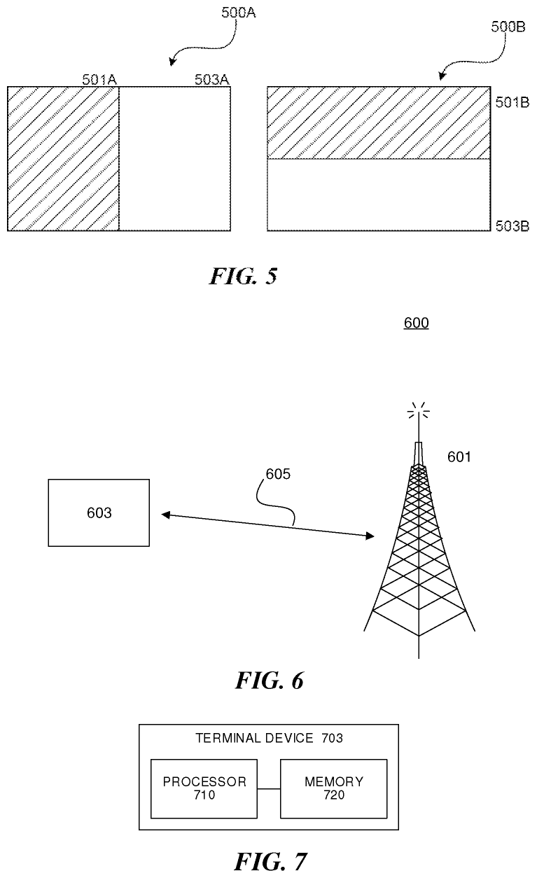

At step 305, an adjusted residual block size is set to be a half or a quarter of the current residual block size. The size and orientation of the adjusted residual block size is dependent on the value of other flags related to the SBT tool, which is described below with reference to FIG. 5. The method 300 then moves to decision step 309.

At step 307, if the SBT tool is not enabled the method 300 sets an adjusted residual block size the same as the current residual block size. The method 300 then also moves to decision step 309.

At decision step 309, the method 300 continues by checking a current prediction method. As described above with reference to the intra prediction module 102 and the inter prediction module 103, while the current prediction method can be categorized roughly as intra or inter, it may also exercise any of several intra or inter prediction tools. The non-separable transform may be disabled for prediction tools or sub-modes of prediction tools where there is no coding benefit. At decision step 309 the method 300 checks whether the non-separable transform is disabled for the current prediction tool or sub-mode of the current prediction tool. If the non-separable transform is disabled, the method 300 moves to step 327. Otherwise, if non-separable transform is enabled and the current prediction method is intra, the method 300 moves to step 311. If the non-separable transform is enabled and the current prediction method is inter, the method 300 moves to step 313.

In some embodiments of decision step 309, the non-separable transform is disabled for affine mode inter prediction. In some embodiments of decision step 309, the non-separable transform is disabled for sub-block mode inter prediction.

In some embodiments of decision step 309, the non-separable transform is enabled for the SBT tool. In other embodiments of decision step 309, the non-separable transform is enabled for the SBT tool when a half split has been signaled, but disabled for the SBT tool when a quad split has been signaled.

At step 327, the “nst_idx” parameter is inferred as “0”, and therefore “nst_idx” is not decoded from the bitstream 12. The method 300 then moves to step 329.

At step 329, in response to “nst_idx” having a value of “0”, the method 300 determines that the non-separable transform is not used. The method 300 then terminates.

At step 311, in response to the non-separable transform being enabled for the current intra prediction method, the method 300 selects a non-separable kernel of dimension “A×B×C×D” based on an adjusted residual block size. The non-separable kernel dimensions can be determined from the adjusted residual block size based on Table 2. A maximum number of non-separable transform coefficients (T) is set equal to the value “B” of the selected non-separable kernel of dimension “A×B×C×D”. The method 300 then moves to decision step 315.

At step 313, in response to the non-separable transform being enabled for the current inter prediction method, in some arrangements the method 300 selects a non-separable kernel of dimension “A×B×C×D” based on the adjusted residual block size. As in step 311, the non-separable kernel dimensions can be determined from the adjusted residual block size based on Table 2. The maximum number of non-separable transform coefficients (T) is set equal to the value “B” of the selected subset non-separable kernel of dimension “A×B×C×D”.

In other embodiments of step 313, the method 300 selects a subset of a kernel (“A×K×C×D”) based on the adjusted residual block size. For example, the dimension of the subset of the kernel can be determined from the adjusted residual block size based on Table 4. The maximum number of non-separable transform coefficients (T) is set equal to the value “K” of the selected subset non-separable kernel of dimension “A×K×C×D”. The method 300 then moves to decision step 315.

At decision step 315, the method 300 determines if the number of coefficients N is greater than the maximum number of transform coefficients T. If N is greater than T, the method 300 moves to step 327. Otherwise (N is less than or equal to T), the method 300 moves to step 317.

At step 317, the method 300 decodes the “nst_idx” from the bitstream 12. The method 300 then moves to decision step 319.

At decision step 319, if the value of the parameter “nst_idx” is “0”, the method 300 moves to step 329. Otherwise (“nst_idx” has a value of “1”, “2” or “3”), the method 300 moves to step 321.

At step 321, the method 300 determines that the non-separable transform is used. The method 300 then terminates.

FIG. 4A is a schematic diagram illustrating a gradient analysis process in accordance with one or more implementations of the present disclosure. In some embodiments, an intra prediction mode can be derived by applying a DIMD-like process to a reference block 403 of a uni-predicted inter CU 401. As shown in FIG. 4A, a “3×3” gradient analyzing window 405 can be moved over the reference block 403. At each position of the gradient analyzing window 405, a local gradient can be calculated by applying filters (such as Sobel filters). The local gradients can be accumulated in a histogram, with the gradient corresponding to the highest count in the histogram being used to select the intra-prediction mode. In some embodiments, the gradient analyzing window 405 can be moved in increments of one sample, thus covering every position within the reference block 403. In other embodiments, the gradient analyzing window 405 can be moved in increments of “N” samples at a time. The foregoing arrangement enables faster implementation of the histogram calculation and flexibility of coding operations.

FIG. 4B is a schematic diagram illustrating a template matching process in accordance with one or more implementations of the present disclosure. In some embodiments, an intra prediction mode can be derived by applying a TIMD-like process to a reference block 413 of a uni-predicted inter CU 411. For each candidate intra-prediction mode, a prediction for the reference block 413 can be produced from the neighboring reference samples 415 by an intra angular prediction method. The candidate intra-prediction mode which produces a predictor that best matches the reference block samples 413 can be selected as the intra prediction mode for indexing a transform set from a non-separable transform kernel. In some embodiments, the best match can be determined by finding the predictor that minimizes the sum of absolute differences (SAD), or the sum of absolute transformed differences (SATD), or by comparing hashes between the predictor and the reference block 413. In some embodiments, in cases where multiple reference blocks are used such as bi-predicted inter CUs, the intra-prediction mode can be derived by applying a TIMD-like process to multiple reference blocks. In such embodiments, the intra-prediction mode is selected by comparing a weighted combination of the reference blocks against a weighted combination of the predictions for each reference block.

FIG. 5 is a schematic diagram illustrating partitioning by the SBT tool in accordance with one or more implementations of the present disclosure. When the SBT tool is enabled, a further SBT direction flag is signaled to indicate whether the CU is partitioned by a horizontal or vertical split. As shown in FIG. 5, when the SBT direction flag indicates a horizontal split, a first example CU 500A is partitioned by a horizontal split. When the SBT direction flag indicates a vertical split, a second example CU 500B is partitioned by a vertical split.

The example CUs 500A and 500B include hatched regions 501A and 501B respectively, and white regions 503A and 503B respectively. A further SBT position flag is signaled to indicate which region is selected for inverse transform, and which region is zeroed out. For example, when the SBT position flag is “1” the hatched region can be selected for inverse transform and the white region is zeroed out, and when the SBT position flag is “0” the white region can be selected for inverse transform and the hatched region is zeroed out. From an encoder perspective, the forward transform is only applied to the selected region to produce transform coefficients. From a decoder perspective, an inverse non-separable transform can be applied to the transform coefficients to produce residual samples that fill the selected region. Therefore, the adjusted residual block size is equal to the size of the selected region.

The size of the selected region and zeroed-out region are depicted as equal in the examples of FIG. 5. However, the size of the selected region is determined by a further SBT quad flag. When the SBT quad flag is “0”, then the selected region is half the size of the CU (i.e., the selected region and zeroed-out region are equal in size). For the case of a horizontal split, the adjusted residual block size will have height equal to the CU height, and width half of the CU width. For the case of a vertical split, the adjusted residual block size will have height half of the CU height, and width equal to the CU width. When the SBT quad flag is “1”, then the selected region is one quarter the size of the CU. For the case of a horizontal split, the adjusted residual block size will have height equal to the CU height, and width one quarter of the CU width. For the case of a vertical split, the adjusted residual block size will have height one quarter of the CU height, and width equal to the CU width.

FIG. 6 is a schematic diagram of a wireless communication system 600 in accordance with one or more implementations of the present disclosure. The wireless communication system 600 can implement the framework discussed herein. As shown in FIG. 6, the wireless communications system 600 can include a network device (or base station) 601. Examples of the network device 601 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 601 can include a relay station, an access point, an in-vehicle device, a wearable device, and the like. The network device 601 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as a new radio (New Radio, NR) system or network.

In FIG. 6, the wireless communications system 600 also includes a terminal device 603. The terminal device 603 can be an end-user device configured to facilitate wireless communication. The terminal device 603 can be configured to wirelessly connect to the network device 601 (via, e.g., via a wireless channel 605) according to one or more corresponding communication protocols/standards. The terminal device 603 may be mobile or fixed. The terminal device 603 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 603 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like.

For illustrative purposes, FIG. 6 illustrates only one network device 601 and one terminal device 603 in the wireless communications system 600. However, in some instances, the wireless communications system 600 can include additional network device 601 and/or terminal device 603.

FIG. 7 is a schematic block diagram of a terminal device 703 (e.g., which can implement the methods discussed herein) in accordance with one or more implementations of the present disclosure. As shown, the terminal device 703 includes a processing unit 710 and a memory 720. The processing unit 710 can be configured to implement instructions that correspond to the methods discussed herein and/or other aspects of the implementations described above. It should be understood that the processor 710 in the implementations of this technology may be an integrated circuit chip and has a signal processing capability. During implementation, the steps in the foregoing method may be implemented by using an integrated logic circuit of hardware in the processor 710 or an instruction in the form of software. The processor 710 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 710 may be a microprocessor, or the processor 710 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 720, and the processor 710 reads information in the memory 720 and completes the steps in the foregoing methods in combination with the hardware thereof.

It may be understood that the memory 720 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache.

For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

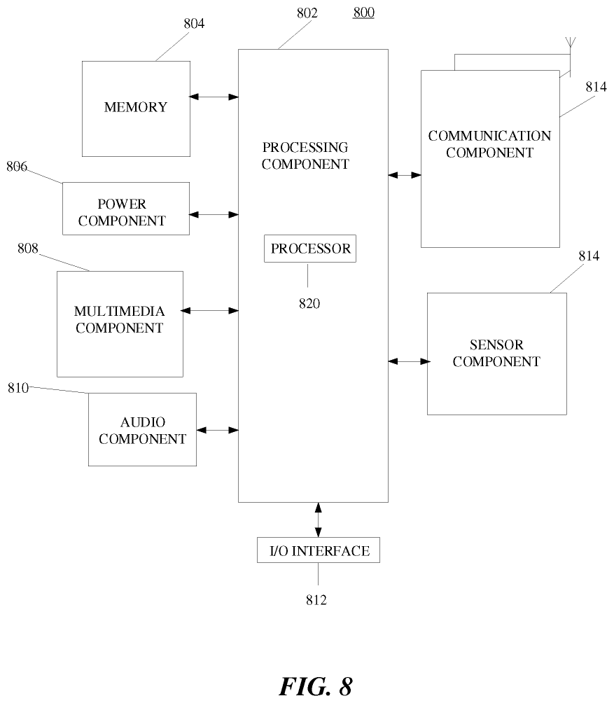

FIG. 8 is a schematic block diagram of an electronic device 800 in accordance with one or more implementations of the present disclosure. The electronic device 800 may include one or more following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device. Examples of such data include instructions for any application programs or methods operated on the electronic device, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 provides power for various components of the electronic device. The power component 806 may include a power management system, one or more power supplies, and other components associated with generation, management and distribution of power for the electronic device.

The multimedia component 808 may include a screen providing an output interface between the electronic device and a user. In some embodiments, the screen may include a Liquid Crystal Display (LCD) and a Touch Panel (TP). If the screen may include the TP, the screen may be implemented as a touch screen to receive an input signal from the user. The TP may include one or more touch sensors to sense touches, swipes and gestures on the TP. The touch sensors may not only sense a boundary of a touch or swipe action but also detect a duration and pressure associated with the touch or swipe action. In some embodiments, the multimedia component 808 may include a front camera and/or a rear camera. The front camera and/or the rear camera may receive external multimedia data when the electronic device is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 may include a Microphone (MIC), and the MIC is configured to receive an external audio signal when the electronic device is in the operation mode, such as a call mode, a recording mode and a voice recognition mode. The received audio signal may further be stored in the memory 804 or sent through the communication component 816. In some embodiments, the audio component 810 further may include a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 may include one or more sensors configured to provide status assessment in various aspects for the electronic device. For instance, the sensor component 814 may detect an on/off status of the electronic device and relative positioning of components, such as a display and small keyboard of the electronic device, and the sensor component 814 may further detect a change in a position of the electronic device or a component of the electronic device, presence or absence of contact between the user and the electronic device, orientation or acceleration/deceleration of the electronic device and a change in temperature of the electronic device. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device and other equipment. The electronic device may access a communication-standard-based wireless network, such as a WIFI network, a 2nd-Generation (2G) or 3G network or a combination thereof. In an exemplary embodiment, the communication component 816 receives a broadcast signal or broadcast associated information from an external broadcast management system through a broadcast channel. In an exemplary embodiment, the communication component 816 further may include a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a Bluetooth (BT) technology and another technology.

In an exemplary embodiment, the electronic device 810 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as the memory 804 including an instruction, and the instruction may be executed by the processing component 802 of the electronic device 800 to implement the methods discussed herein. For example, the non-transitory computer-readable storage medium may be a ROM, a Random Access Memory (RAM), a Compact Disc Read-Only Memory (CD-ROM), a magnetic tape, a floppy disc, an optical data storage device and the like.

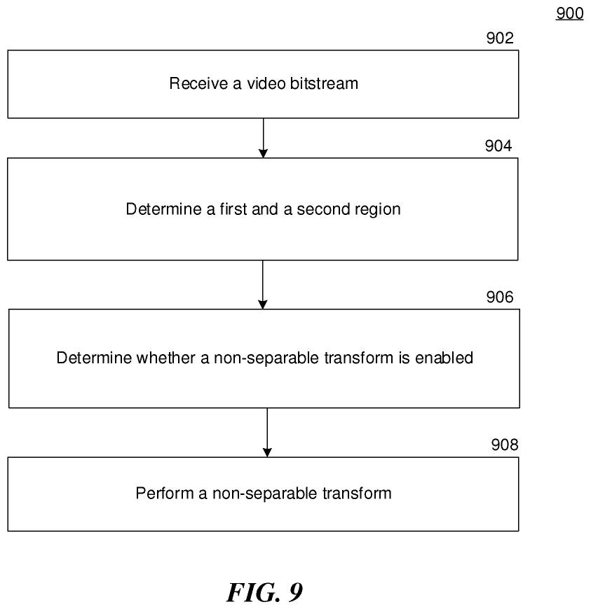

FIG. 9 is a flowchart of a decoding method 900 in accordance with one of more implementations of the present disclosure. The method 900 can be implemented by a system or an apparatus (such as the decoding system 100B or an apparatus having an inverse transform module discussed herein).

The method 900 begins at a step 902 by receiving a video bitstream. The method 900 then continues to a step 904. At step 904, the method 900 determines a first and second region of a current block, wherein the second region is a region in the current block excluding the first region. The first and second regions may be determined in some embodiments by parameters of a sub-block transform partitioning tool. In some other embodiments where a sub-block transform partitioning is not applied, the first region may be the same as the current block, in which case the second region is empty. The method 900 then continues to a step 906. At step 906, the method 900 determines whether a non-separable transform is enabled. If the non-separable transform is enabled, the method 900 continues to a step 908. Otherwise, the method terminates. At step 908, the method 900 derives samples in the first region of the current block by performing a non-separable transform on one or more coefficients. The non-separable transform may also be referred to as an inverse non-separable transform, as described elsewhere in this disclosure. The one or more coefficients may be transform coefficients for the current block that have been decoded from the video bitstream. The method 900 then terminates.

In some embodiments, the first and second regions are determined by partitioning the current block into two sub-blocks. The current block may also be referred to as a residual block, or a prediction block, or a coding block, or a coding unit. The first and second regions may also be referred to as transform blocks.

In some embodiments, the size and position of the first region is determined from parameters of a sub-block transform partitioning, as described above with reference to FIG. 5. In some embodiments, the size of the first region is one-quarter of the current block if a quad parameter is set, or one-half of the current block otherwise. In some embodiments, the first region is determined by partitioning the current block by a vertical or horizontal split depending on a direction parameter.

In some embodiments, the position of the first region is at the top-left of the current block if a position parameter is set, and at the bottom-right of the current block otherwise.

In some embodiments, the non-separable transform may be a non-separable primary transform.

In some embodiments, the samples in the second region of the current block may be set to 0.

In some embodiments, the non-separable transform is enabled in response to determining that a “nst_idx” parameter has a value other than “0”.

In some embodiments, the nst_idx parameter may be inferred as 0 (i.e. the non-separable transform is disabled) in response to a current prediction method being an affine inter prediction method.

In some embodiments, the nst_idx parameter may be inferred as 0 (i.e. the non-separable transform is disabled) in response to a current prediction method being a sub-block inter prediction method.

In some embodiments, in response to the nst_idx parameter having a value other than “0”, the non-separable transform is performed using a non-separable transform matrix, where the non-separable transform matrix is selected from a non-separable transform kernel according to the value of the nst_idx parameter and the value of an intra prediction mode. The non-separable transform kernel may be selected in response to the size of the current block.

In some embodiments, in response to the current prediction method being an inter prediction method, the intra prediction mode may be derived by applying a DIMD-like process. In other embodiments, the intra prediction mode may be derived by a TIMD-like process.

In some embodiments, the non-separable transform matrix may be additionally selected according to the type of inter prediction method.

In some embodiments, step 906 of the method 900 further comprises determining a number “N” of the one or more coefficients, and determining a maximum number “T” of non-separable transform coefficients. In response to determining that “N” is less than or equal to “T”, the method 900 decodes the nst_idx parameter from the video bitstream. Otherwise (“N” is greater than “T”), the method 900 infers the nst_idx parameter to have a value of “0”.

In some embodiments, the maximum number of non-separable transform coefficients “T” is set equal to a size “B” of a dimension of the selected non-separable transform kernel.

In some embodiments of step 906 of method 900, if the size of the first region is one-quarter of the current block, the non-separable transform is not enabled.

### ADDITIONAL CONSIDERATIONS

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A method for video decoding, comprising:
determining a first region and a second region of a current block, wherein the second region is a region in the current block excluding the first region; and
deriving samples in the first region of the current block by performing a non-separable transform on one or more coefficients.

2. The method of claim 1, wherein the first and second regions are determined by partitioning the current block into two sub-blocks.

3. The method of claim 2, wherein the size and position of the first region is determined from parameters of a sub-block transform partitioning.

4. The method of claim 3, wherein the size of the first region is one-quarter of the current block if a quad parameter, or a first parameter indicating the size of the first region is set, or one-half of the current block otherwise; and
the first region is determined by partitioning the current block by a vertical or horizontal split depending on a direction parameter, or a second parameter indicating directionality of the partitioning.

5. The method of claim 3, wherein the position of the first region is at the top-left of the current block if a position parameter, or a third parameter indicating position of the first region is set, and at the bottom-right of the current block otherwise.

6. The method of claim 1, wherein the non-separable transform is a non-separable primary transform.

7. The method of claim 1, further comprising setting samples in the second region of the current block to be equal to 0.

8. A method for video encoding, comprising:
determining a first region and a second region of a current block, wherein the second region is a region in the current block excluding the first region; and
deriving one or more coefficients by performing a non-separable transform on samples in the first region of the current block.

9. The method of claim 8, wherein the first and second regions are determined by partitioning the current block into two sub-blocks.

10. The method of claim 9, wherein the size and position of the first region is determined from parameters of a sub-block transform partitioning.

11. The method of claim 10, wherein the size of the first region is one-quarter of the current block if a quad parameter, or a first parameter indicating the size of the first region is set, or one-half of the current block otherwise; and
the first region is determined by partitioning the current block by a vertical or horizontal split depending on a direction parameter, or a second parameter indicating directionality of the partitioning.

12. The method of claim 10, wherein the position of the first region is at the top-left of the current block if a position parameter, or a third parameter indicating position of the first region is set, and at the bottom-right of the current block otherwise.

13. The method of claim 8, wherein the non-separable transform is a non-separable primary transform.

14. The method of claim 8, further comprising setting samples in the second region of the current block to be equal to 0.

15. A method for video decoding, comprising:
receiving a video bitstream;
determining whether a non-separable transform is enabled for a current block; and
in response to a determination that the non-separable transform is enabled, deriving samples in the current block by performing a non-separable transform on one or more coefficients decoded from the video bitstream.

16. The method of claim 15, wherein the non-separable transform is enabled in response to determining that a “nst_idx” parameter has a value other than “0”.

17. The method of claim 16, further comprising:
determining a number (“N”) of the one or more coefficients;
determining a maximum number of non-separable transform coefficients (“T”); and
in response to a determination that “N” is less than or equal to “T”, decoding the nst_idx parameter from the video bitstream, or otherwise inferring the nst_idx parameter to have a value of “0”.

18. The method of claim 17, wherein the maximum number of non-separable transform coefficients “T” is set equal to a size “B” of a dimension of the selected non-separable transform kernel.

19. The method of claim 17, wherein the maximum number of non-separable transform coefficients “T” is set to a value less than a size “B” of a dimension of the selected non-separable transform kernel.

20. A non-transitory computer-readable storage medium storing computer programs and a bitstream, wherein when executed by a processor, the computer programs cause the processor to perform the method of claim 8 to generate the bitstream.
